(19) United States
(12) Patent Application Publication
(10) Pub. No.: US 2017/0297463 A1
(43) Pub. Date: Oct. 19, 2017

(54) SEAT SITTING PART VIBRATION DEVICE

(71) Applicant: Nidec Copal Corporation, Tokyo (JP)

(72) Inventors: Hidekuni YOSHIKAWA, Tokyo (JP); Masaru WADA, Tokyo (JP); Hiroshi MUROYA, Tokyo (JP); Hideaki NAKAMURA, Tokyo (JP)

(73) Assignee: Nidec Copal Corporation, Tokyo (JP)

(21) Appl. No.: 15/512,668

(22) PCT Filed: Sep. 11, 2015
(86) PCT No.: PCT/JP2015/075790

§ 371 Date: Mar. 20, 2017

(30) Foreign Application Priority Data
Sep. 24, 2014 (JP) 2014-194475
Mar. 13, 2015 (JP) 2015-050558

(51) Int. Cl. B60N 2/44; A47C 7/62

(52) U.S. Cl. CPC B60N 2/448; A47C 7/62; B60N 2002/4485

(57) ABSTRACT

A seat seating portion vibrating apparatus with high reliability and high durability. The seat seating portion vibrating apparatus includes an electric motor that comprises a rotary shaft that is disposed along a seating surface of a seat; a weight that is attached to the rotary shaft; and a case for containing the electric motor and the weight therein. The case is provided therein with a wiring space for flexing and connecting a harness for the electric motor, and is provided with a harness extending portion wherein the harness extends downward, perpendicular to the seating surface.

### CROSS-REFERENCE TO RELATED APPLICATIONS

This is a U.S. national phase application under 35 U.S.C. §371 of International Patent Application No. PCT/JP2015/075790, filed Sep. 11, 2015, and claims benefit of priority to Japanese Patent Application Nos. 2015-050558, filed Mar. 13, 2015 and 2014-194475, filed Sep. 24, 2014. The entire contents of these applications are hereby incorporated by reference.

### FIELD OF TECHNOLOGY

The present invention relates to a seat seating portion vibrating apparatus for transmitting information to a seated party (a driver) through vibrating the seating portion of a seat.

### BACKGROUND

The installation, into, for example, a seat for vehicular use, of a vibration generator for transmitting various types of information to a seated party (the driver, or the like) through vibrations is known (see, for example, Japanese Unexamined Patent Application Publication No. 2006-341839). In this prior art, a vibration generator is disposed within the seating portion in a seat, where vibration generators of the linear motor type, wherein the vibrating body is caused to undergo reciprocating vibration through electromagnetic forces, and of the rotary motor type, for driving a rotary shaft with a weight installed on the tip end thereof, are known.

### SUMMARY

In the prior art set forth above, when a vibration generator of the rotary motor type, wherein a weight is attached to the tip end of the rotary shaft and caused to vibrate, the rotary shaft is disposed along the seating surface of the seat, and the harness of the electric motor for driving the rotary shaft also leads out along the seating surface of the seat, and thus the load of the passenger who is seated on the seating surface applies a bending force to the harness, which sometimes causes the harness to break at the lead portion (the base portion), and thus there has been a problem in that there has been a tendency to produce open circuit faults.

The handling of such a problem is an example of the problem to be solved in the present invention. That is, an object of the present invention is to prevent damage to the harness extending portion, and to prevent open circuit faults in harnesses, in a seat seating portion vibrating apparatus for vibrating the seating portion of a seat.

In order to achieve such an object, the seat seating portion vibrating apparatus according to the present invention comprises the following structures:

A seat seating portion vibrating apparatus comprising: an electric motor comprising a rotary shaft, disposed along a seating surface of a seat; a weight that is attached to the rotary shaft; and a case for containing the electric motor and the weight therein, wherein: the case is provided therein with a wiring space wherein a harness for the electric motor is flexed and connected, and is provided with a harness extending portion wherein the harness leads out downward, perpendicular to the seating surface.

With the seat seating portion vibrating apparatus that has such distinctive features, the load when a person is seated on the seating surface of the seat does not apply a bending force to the harness, enabling prevention of damage to the harness extending portion and preventing open circuit faults in the harness, thereby enabling a seat seating portion vibrating apparatus that has high reliability and high durability.

### BRIEF DESCRIPTIONS OF THE DRAWINGS

FIG. 1 is a partial cross-sectional view illustrating the internal structure of a seat seating portion vibrating apparatus according to an example according to the present invention.

FIG. 2 is an exploded perspective diagram illustrating the internal structure of the seat seating portion vibrating apparatus according to the example according to the present invention.

FIG. 3 is an explanatory diagram (a perspective diagram) illustrating a seat in which is installed the seat seating portion vibrating apparatus according to the example according to the present invention.

FIG. 4 is an explanatory diagram (a perspective diagram) illustrating a state wherein the seat seating portion vibrating apparatus according to the example according to the present invention is installed in the seat.

FIG. 5 is an explanatory diagram illustrating an example of another form of an electric motor in a seat seating portion vibrating apparatus according to an example according to the present invention.

FIG. 6 is an explanatory diagram illustrating the internal structure of a case for containing the electric motor illustrated in FIG. 5.

FIG. 7 is an explanatory diagram showing the curve for the vibrational forces with respect to time generated by the seat seating portion vibrating apparatus according to the example according to the present invention and the curve for the vibrational forces with respect to time generated by a vibrating apparatus that is not provided with the elastic member and case.

FIG. 8 is an explanatory diagram illustrating a seat that is provided with a seat seating portion vibrating apparatus according to an example according to the present invention, and a vehicle in which the seat is installed.

### DETAILED DESCRIPTION

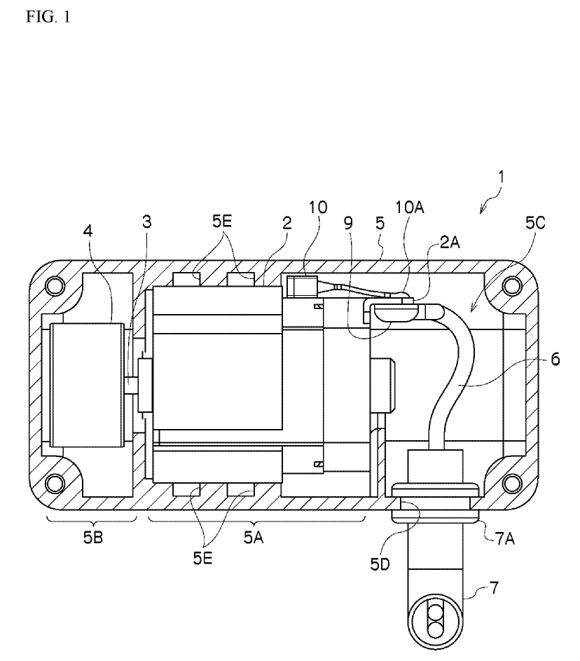

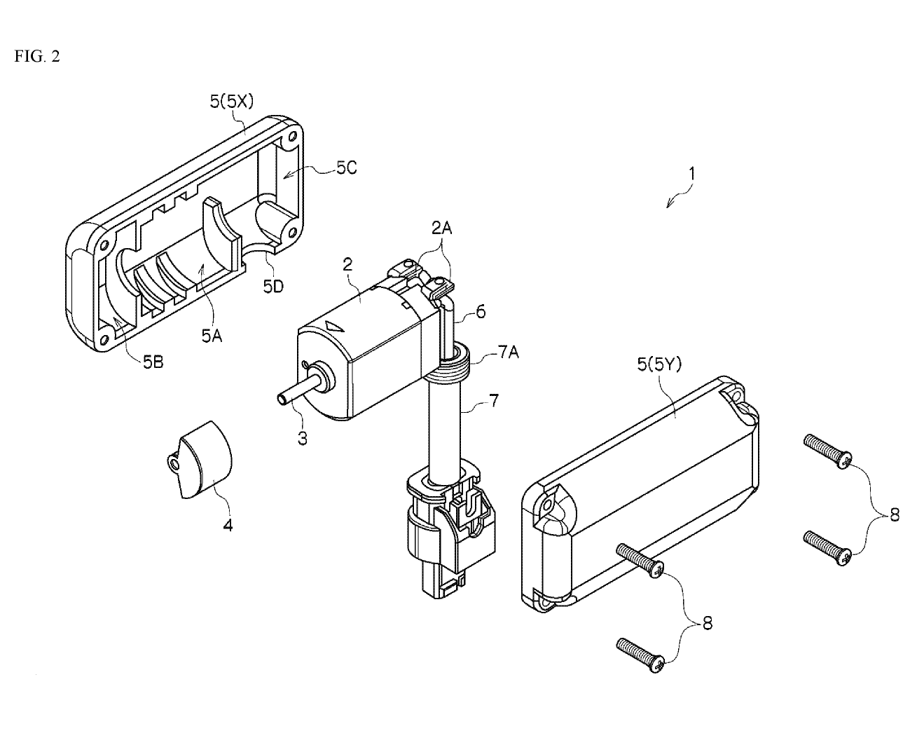

An example according to the present invention will be explained below in reference to the drawings. In FIG. 1 and FIG. 2, a seat seating portion vibrating apparatus 1 according to an example according to the present invention comprises: an electric motor 2 that comprises a rotary shaft 3; a weight 4 that is attached to the rotary shaft 3; and a case 5 that contains the electric motor 2 and the weight 4 therein. Here the rotary shaft 3 that is driven rotationally by the electric motor 2 is disposed in a direction along the seating surface of the seat, described below (in the crosswise direction).

The case 5 has an electric motor storing portion 5A for containing the electric motor 2 therein, and a weight storing portion 5B for containing the weight 4. Moreover, the case 5 has provided therein a wiring space 5C wherein the harness 6 of the electric motor 2 is flexed and connected, and is provided with a harness extending portion 5D through which the harness 6 extends. Moreover, on the inner surface of the case 5 there is a plurality of ribs 5E, which are protruding shapes that protrude inward, disposed with spaces therebetween in the direction of length of the rotary shaft 3. The electric motor 2 is placed in the part of the case 5 wherein the ribs 5E are provided.

Here a pair of terminals 2A for the electric motor 2 is provided on the side that is opposite from the direction of protrusion of the rotary shaft 3, where an end portion of the harness 6 is connected to the terminals 2A. The harness 6 extends slightly in parallel with the rotary shaft 3 from the end portion that is connected to the terminal 2A, and the tip end thereof is flexed to connect within the wiring space 5C. Given this, the harness extending portion 5D through which the harness 6 extends is disposed so that the harness 6, which is enclosed in a protective tube 7, extends downwards, perpendicular to the seating surface, when installed in the seat.

The harness 6 is connected, with extra length, in a state wherein it is flexed in the wiring space 5C. The two terminals 2A of the electric motor 2 are disposed on one side away from the rotary shaft 3 in the direction that is perpendicular to the rotary shaft 3, with the individual terminals 2A lined up so as to be coplanar. Given this, when the electric motor 2 is placed within the case 5, the terminals 2A are disposed positioned on the side that is not the side of the harness extending portion 5D within the case 5. The wiring space 5C between the harness extending portion 5D and the terminals 2A is secured thereby.

The end portion of the harness 6 is secured by solder 9 to the connecting faces (the bottom faces) of the rotary shaft 3 side of the terminals 2A. That is, the connecting faces of the terminals 2A face the harness extending portion 5D. Consequently, even if a large force were to act in the perpendicular direction, the force would be in the direction wherein the harness 6 would press the connecting faces against the terminals 2A, so there would be no force from the terminals 2A in the direction wherein the harness 6 would be disconnected, making it possible to prevent disconnection. A terminal 10A of a capacitor 10 is connected to the faces of the terminals 2A that are on the opposite side from the harness extending portion 5D (the top face).

As illustrated in FIG. 2, the case 5 is structured from divided bodies 5X and 5Y, joined together by screws 8. In the weight storing portion 5B, the electric motor storing portion 5A, and the wiring space 5C of the case 5, the harness extending portion 5D that is arranged along the rotary shaft 3 of the electric motor 2 that is contained within the case 5, and which connects to the wiring space 5C is open in a direction that is essentially perpendicular to the rotary shaft 3. Moreover, the harness extending portion 5D, which is formed by the divided bodies 5X and 5Y of the case 5, holds the protecting tube 7, by holding a recessed portion of an attaching portion 7A of the protecting tube 7 between the divided bodies 5X and 5Y.

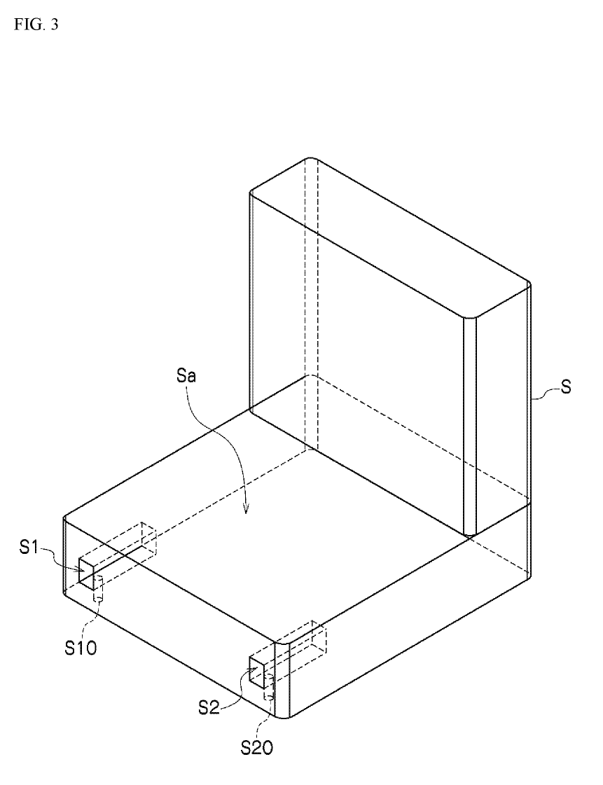

FIG. 3 illustrates a seat wherein the seat seating portion vibrating apparatus 1 is installed. The seat S is provided with attaching portions S1 and S2 below the seating surface Sa thereof The attaching portions S1 and S2 are spaces that are formed in, for example, the foam rubber within the seat, formed in the shapes of holes that are elongated along the seating surface Sa. Moreover, respective harness lead holes S10 and S20 are formed on the bottom sides of the attaching portions S1 and S2.

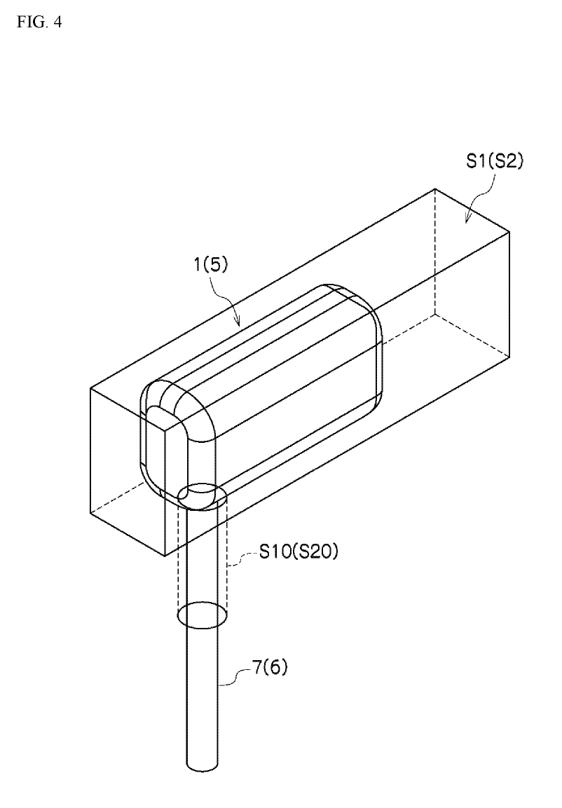

FIG. 4 illustrates a state wherein the seat seating portion vibrating apparatus 1 is installed in the seat. The seat seating portion vibrating apparatus 1 is arranged so that the direction of the rotary shaft 3 within the space of the attaching portion S1 (and S2) will be along the seating surface Sa, with the protecting tube 7 that encloses the harness 6 leading out downward through the harness lead hole S10 (S20).

Given such a seat seating portion vibrating apparatus 1, the harness 6 is flexed within the case 5, and the harness 6 leads out directly downward from the bottom side of the case 5. Through this, even if the rotary shaft 3 of the seat seating portion vibrating apparatus 1 is disposed along the seating surface Sa, the load received by the person sitting upon the seating surface Sa does not act on the harness 6 in the bending direction. The downward load received by the seating surface Sa pushes the case 5 downward, but the harness 6 leads out along the harness lead hole S10 (S20) that opens facing downward, so the harness 6 itself does not bear a large load, but rather slides within the harness lead hole S10 (S20).

In this way, in the seat seating portion vibrating apparatus 1 according to the example according to the present invention, the load when a person is seated on the seating surface Sa of the seat S does not apply a bending force to the harness 6, thus preventing damage to the harness extending portion 5D and preventing open circuit faults in the harness 6, enabling achievement of a seat seating portion vibrating apparatus 1 that has high reliability and high durability.

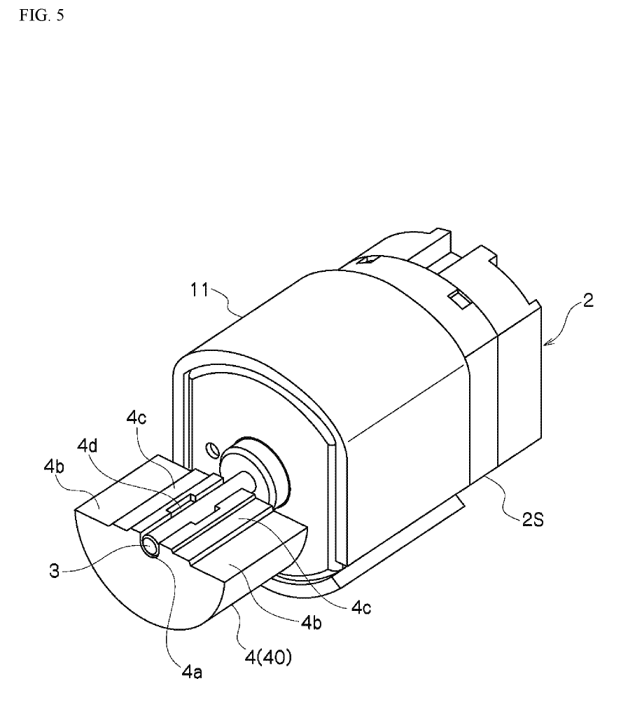

FIG. 5 illustrates an example of another form of an electric motor 2 in a seat seating portion vibrating apparatus 1. This electric motor 2 comprises a motor main unit 2S and an elastic member 11 that is attached on the outer surface thereof, and generates vibrations through rotating a weight 4 that is secured to the rotary shaft 3 of the electric motor 2. The motor main unit 2S of the electric motor 2 is equipped with, for example, a magnet and a coil for rotating the rotary shaft 3, and a motor case for containing the magnet and the coil. The motor case has, for example, a hole through which the rotary shaft 3 passes, where the rotary shaft 3 is supported so as to enable rotation centered on an axis in the lengthwise direction of the rotary shaft 3. That is, the outer surface of the motor case is, essentially, the outer surface of the motor main unit 2S.

The weight 4 has a shape wherein, when viewed from the lengthwise direction of the rotary shaft 3, the position of the center of gravity is different from the position of the center of the rotary shaft 3, so that a vibration is generated when the rotary shaft 3 is rotated. The weight 4, as described above, generates a vibration with a vibrational force that is large enough to propagate to the operator through the cushion member (foam rubber), or the like, of the seat S. Generally the vibrational force is expressed by F=m×r×ω², where F is the vibrational force, m is the mass of the weight 4, r is the difference between the center of gravity of the weight 4 and the center of the rotary shaft 3, when viewed from the lengthwise direction of the rotary shaft 3, and ω is the angular velocity of the rotary shaft 3.

The weight 4 in the present example is made using a sintered iron metal as the primary material thereof. Because a sintered iron metal has a lower melting point than tungsten, which is conventionally employed as a weight, it can be manufactured easily using injection molding. Moreover, because sintered iron metal is softer than tungsten, or the like, it can be crimped easily. An oxidize film is provided on the surface of the weight 4 to prevent rusting.

The weight 4 has: a fan-shaped main unit portion 40 wherein is provided a semicircular groove portion 4a into which the rotary shaft 3 fits; a pair of rib portions 4c and 4c that protruded outward from respective fan-shaped radial parts 4b and 4b that form the main unit portion 40, so as to form inner wall portions that connect to each end portion of the groove portion 4a, and crimped portions 4d wherein portions of the pair of rib portions 4c and 4c are crimped.

Each of the pair of rib portions 4c and 4c has a stepped portion, forming a stepped shape, between the tip end and the base end for connecting to the fan-shaped radial parts 4b and 4b that form the main unit 40 portion, when viewed from the lengthwise direction of the rotary shaft 3.

The crimped portions 4d are parts that are formed so as to press prescribed portions of the pair of rib portions 4c and 4c at, essentially, the center in the lengthwise direction of the rotary shaft 3. The crimped portions 4d are formed through being pressed with a crimping tool, or the like, that has an essentially rectangular pressing portion. The weight 4 is secured onto the rotary shaft 3 by the crimped portion 4d.

In the present example, the tip end of the rotary shaft 3 is positioned at the same position as one face of the weight 4, in the lengthwise direction of the rotary shaft 3, where the tip end of the rotary shaft 3 and the face of the weight 4 are secured together by a welded portion 4e that is formed through welding. The rotary shaft 3 and the weight 4 are secured together more securely thereby. Note that the crimped portion 4d may be provided in a plurality, and may be provided along the entirety of the length direction of the rotary shaft 3. Moreover, the welded portion 4e should be provided at a location that is able to connect the rotary shaft 3 and the weight 4, and may be provided in a plurality.

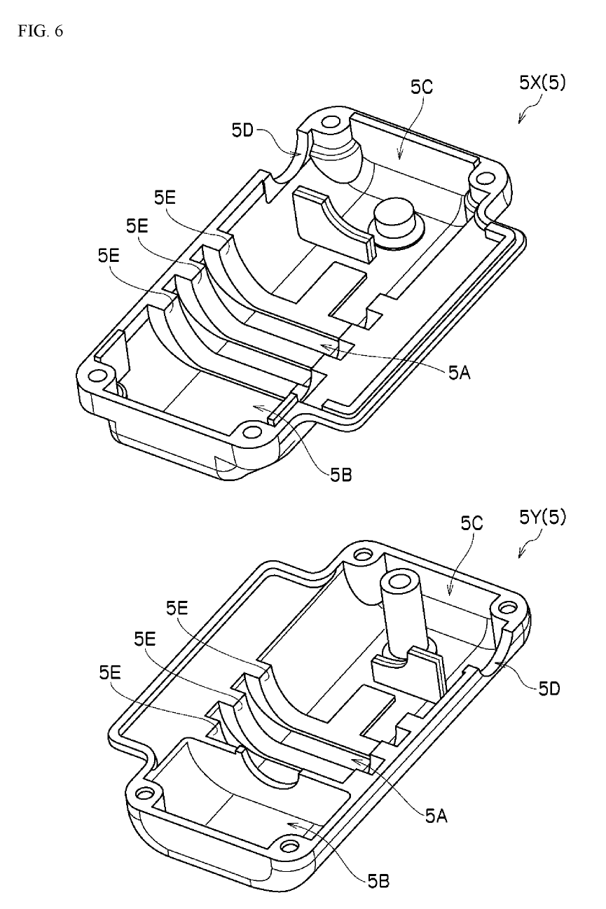

The case 5 for containing the electric motor 2, illustrated in FIG. 5, is structured through combining divided bodies 5X and 5Y, as illustrated in FIG. 6, and fastening using screws, or the like. The structures of the inner surfaces of the individual divided bodies 5X and 5Y are illustrated in FIG. 6. As described above, the divided bodies 5X and 5Y have internal structures for forming the electric motor storing portion 5A, the weight storing portion 5B, the wiring space 5C, and the harness extending portion 5D, where the respective inner surfaces of the divided bodies 5X and 5Y have a plurality of ribs 5E, which are ribs that protrude in the inward direction, with spaces therebetween in the lengthwise direction of the rotary shaft 3. The electric motor 2 is provided in the part where the ribs 5E are provided.

The electric motor 2 is disposed in such divided bodies 5X and 5Y, to be provided on the inner surfaces of both of the divided bodies 5X and 5Y when the divided bodies 5X and 5Y are secured using screws, or the like. The ribs 5E bite into an elastic member 11 that is attached to the outer surface of the motor main unit 2S, so that the electric motor 2 is held securely in the case 5.

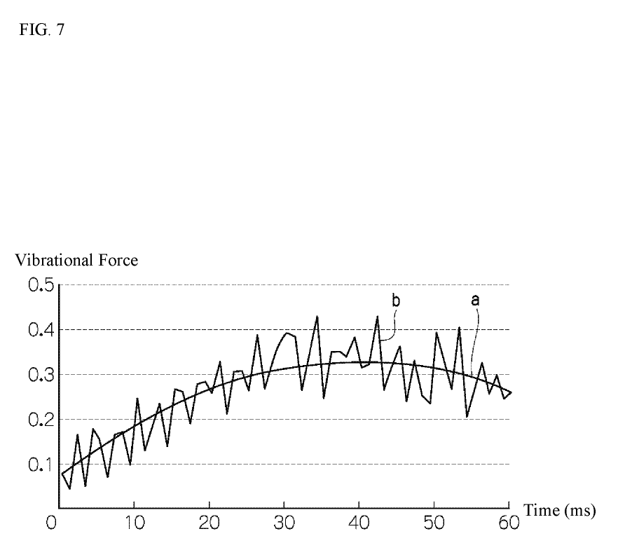

This is able to suppress the occurrence of noise caused by resonance, or the like, in the vibration that is generated by the seat seating portion vibrating apparatus 1, as illustrated in FIG. 7. Here line α that is shown in FIG. 7 is a curve, in respect to time, of the vibrational forces that are generated by the seat seating portion vibrating apparatus 1 according to the present example. Line b shown in FIG. 7 is a curve, in respect to time, of the vibrational forces that are generated by a vibrating apparatus that is not provided with the elastic member 11 and the ribs 5E of the case 5.

Consequently, this is able to reduce the generation of noise caused by the vibration of the seat seating portion vibrating apparatus 1. Moreover, this can reduce the possibility of the vibration of the seat seating portion vibrating apparatus 1 causing discomfort to the user. Furthermore, this enables the user to identify reliably vibration of the seat seating portion vibrating apparatus 1, without confusing it for a vibration that propagates from the road surface, or the like.

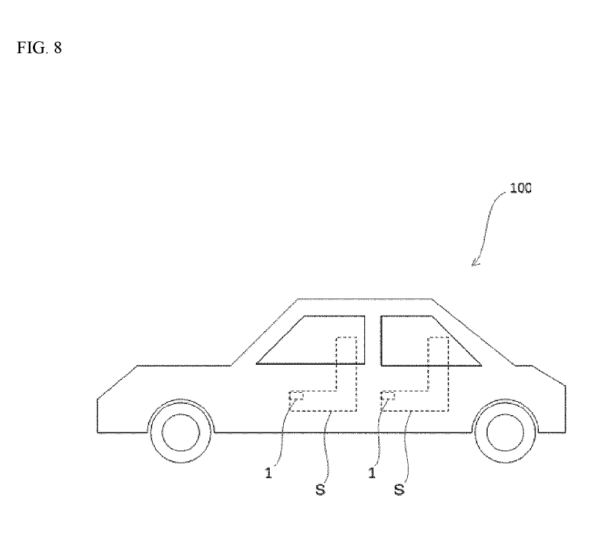

FIG. 8 illustrates a seat S provided with the seat seating portion vibrating apparatus 1 and a vehicle installed with this seat S. The seat seating portion vibrating apparatus 1 has high reliability and high durability, and thus the user who is seated in the seat S that is equipped therewith is able to detect reliably an alarm signal, or the like, through a vibration of the seat seating portion vibrating apparatus 1. Use as a seat S for a vehicle 100 enables a prescribed signal to be transmitted to a user seated in the seat S, without being mistaken for a vibration that is propagated from the road surface. The vehicle 100 that is provided with such a seat S can transmit reliably, to the driver, the vibration that is generated by the seat seating portion vibrating apparatus 1, enabling an improvement in safety of operation.

1. A seat seating portion vibrating apparatus comprising:
an electric motor comprising a rotary shaft, disposed along a seating surface of a seat;
a weight that is attached to the rotary shaft; and
a case containing the electric motor and the weight therein,
wherein the case is provided therein with a wiring space,
wherein a harness for the electric motor is flexed and connected, and is provided with a harness extending portion, and
wherein the harness leads out downward, perpendicular to the seating surface.

2. The seat seating portion vibrating apparatus as set forth in claim 1, wherein:
the terminals of the electric motor are disposed on one side away from the rotary shaft within the case, in a direction that is perpendicular to the rotary shaft, disposed on a side different from the harness extending portion; and
an end portion of the harness is secured to a connecting face that faces the harness extending portion, in the terminal.

3. The seat seating portion vibrating apparatus as set forth in claim 1, wherein:
the electric motor comprises an elastic member on an outer surface of a motor main unit; and
the case, on the interior thereof, is provided with a rib for biting into the elastic member.

4. The seat wherein a seat seating portion vibrating apparatus as set forth in claim 1 is provided below a seating surface.

5. A vehicle comprising a seat as set forth in claim 4.
